(19) United States
(12) Patent Application Publication
(10) Pub. No.: US 2025/0371768 A1
(43) Pub. Date: Dec. 4, 2025

(54) INFORMATION PROCESSING APPARATUS CAPABLE OF REDUCING SENSE OF DISCONTINUITY AT SWITCHING POINT BETWEEN FIRST CLIP OBTAINED BY REMOVING LENS ABERRATION FROM MOVING IMAGE AND SECOND CLIP WHILE IMPARTING ATMOSPHERE OF ACTUAL-PHOTOGRAPHING TO THE SECOND CLIP COMPOSED OF IMAGES THAT DO NOT HAVE LENS ABERRATION, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TOSHITAKA AIBA, Tokyo (JP)

(21) Appl. No.: 19/220,278

(22) Filed: May 28, 2025

(30) Foreign Application Priority Data
May 30, 2024 (JP) 2024-087815

(51) Int. Cl. G06T 11/60

(52) U.S. Cl. CPC G06T 11/60

(57) ABSTRACT

An information processing apparatus capable of, in a combined clip obtained by combining a first clip obtained by removing a lens aberration from a photographed moving image with a second clip composed of images that do not have the lens aberration, reducing a sense of discontinuity at a switching point while imparting an atmosphere of actual-photographing to the second clip is provided. The information processing apparatus obtains a frame image, to which the lens aberration has not been applied, from the combined clip, obtains a frame number of the frame image, and obtains a preset focal length value associated with the frame number from virtual camera information. The information processing apparatus obtains lens metadata corresponding to a focal length value closest to the preset focal length value from lens aberration metadata of the first clip, and applies the lens aberration to the frame image by using the lens metadata.

### CROSS REFERENCE TO PRIORITY APPLICATION

This application claims the benefit of Japanese Patent Application No. 2024-087815, filed on May 30, 2024, which is hereby incorporated by reference herein in its entirety.

### BACKGROUND OF THE INVENTION

### Field of the Invention

The present invention relates to an information processing apparatus, a control method for the information processing apparatus, and a storage medium.

### Description of the Related Art

An information processing apparatus such as a personal computer (a PC) that performs various kinds of processing with respect to an image that has been recorded by photographing with a camera has been known. With an information processing apparatus, for example, an image processing is performed in which an image that does not have a lens aberration such as a peripheral light falloff (a drop in a peripheral light quantity) or a distortion aberration, for example, a computer graphic image (a CG image), is added onto an actually-photographed image that has been recorded by photographing with a camera. In the image processing, first, a first processing that removes the lens aberration from the actually-photographed image is performed, next, a second processing that adds the CG image onto the actually-photographed image, from which the lens aberration has been removed, is performed, and then the lens aberration, which has been removed in the first processing, is applied to a composite image that has been obtained in the second processing. In this way, the same lens aberration as that of the actually-photographed image is also applied to the CG image, which has been added onto the actually-photographed image, and it is possible to generate a natural composite image while imparting an atmosphere of actual-photographing to the CG image.

In addition, with an information processing apparatus, a processing that combines a moving image (a video), which has been recorded by photographing with a camera, with another moving image (another video) or the like in a time series manner is performed. For example, in the case where two different moving images are combined with each other in a time series manner, two pieces of metadata, which are included in the two different moving images, respectively, are compared with each other. As a result of the comparison, in the case where two pieces of photographing mode information, which are included in the two pieces of metadata, respectively, are the same, the metadata is carried over to a combined clip that has been obtained by combining the two different moving images with each other (for example, see Japanese Laid-Open Patent Publication (Kokai) No. 2017-092583). By using lens aberration information included in the metadata, it is possible, for example, to apply the lens aberration of one moving image of the two different moving images, which have been combined with each other, to the other moving image of the two different moving images, thereby generating a combined clip in which a sense of discontinuity at a switching point between the two different moving images has been reduced.

However, with the above-described technique disclosed in Japanese Laid-Open Patent Publication (Kokai) No. 2017-092583, in the case where data other than a moving image photographed in the same photographing mode as the moving image (the video), which has been recorded by photographing with the camera, for example, a CG clip (a CG clip section) composed of CG images, is combined in a time series manner, the metadata will not be carried over to the combined clip. For this reason, it is not possible to obtain information about the lens aberration of a camera material clip section that is composed of the moving image (the video), which has been recorded by photographing with the camera. As a result, it is not possible to perform processing for reducing the sense of discontinuity at a switching point between the camera material clip section and the CG clip section while imparting the atmosphere of the actual-photographing to the CG clip section, such as a processing that removes the lens aberration from the camera material clip section and a processing that applies the lens aberration to the entire combined clip. In addition, even if metadata of the moving image (the video) that constitutes the camera material clip section is carried over, this metadata only includes the information about the lens aberration of the camera material clip section, and therefore it is not possible to apply the lens aberration to the CG clip section so that no the sense of discontinuity occurs at the switching point between the camera material clip section and the CG clip section. In other words, conventionally, it is not possible to reduce the sense of discontinuity at the switching point between the camera material clip section and the CG clip section while imparting the atmosphere of the actual-photographing to the CG clip section.

### SUMMARY OF THE INVENTION

The present invention provides an information processing apparatus capable of, in a combined clip obtained by combining a first clip, which has been obtained by removing a lens aberration from a moving image generated by photographing performed by a photographing apparatus, with a second clip composed of images that do not have the lens aberration, reducing a sense of discontinuity at a switching point between the first clip and the second clip while imparting an atmosphere of actual-photographing to the second clip, a control method for the information processing apparatus, and a storage medium.

Accordingly, the present invention provides an information processing apparatus that generates a combined clip by combining a first clip, which has been obtained by removing a lens aberration from a moving image generated by photographing performed by a photographing apparatus, with a second clip, which is composed of images that do not have the lens aberration, the information processing apparatus comprising at least one processor, and a memory coupled to the processor storing instructions that, when executed by the processor, cause the processor to function as a reading unit that reads metadata of the first clip in which a plurality of pieces of lens metadata corresponding to a plurality of frame images constituting the first clip, respectively, are recorded in association with a photographing setting value used in the photographing, the plurality of pieces of lens metadata each indicating a correction quantity of the lens aberration, an obtaining unit that obtains a frame image, to which the lens aberration has not been applied, from among a plurality of frame images constituting the combined clip, and obtains a frame number of the frame image in the combined clip, a photographing setting value obtaining unit that obtains a first photographing setting value that has been preset in association with the obtained frame number, and a processing unit that obtains lens metadata corresponding to a second photographing setting value, which is closest to the obtained first photographing setting value, from the metadata of the first clip, and performs a processing of applying the lens aberration to the obtained frame image by using the lens metadata.

Accordingly, the present invention provides an information processing apparatus that generates a combined clip by combining a first clip, which has been obtained by removing a lens aberration from a moving image generated by photographing performed by a photographing apparatus, with a second clip, which is composed of images that do not have the lens aberration, the information processing apparatus comprising at least one processor, and a memory coupled to the processor storing instructions that, when executed by the processor, cause the processor to function as a reading unit that reads metadata of the first clip in which a plurality of pieces of lens metadata corresponding to a plurality of frame images constituting the first clip, respectively, are recorded, the plurality of pieces of lens metadata each indicating a correction quantity of the lens aberration, an obtaining unit that obtains a frame image, to which the lens aberration has not been applied, from among a plurality of frame images constituting the combined clip, and obtains a frame number of the frame image in the combined clip, and a processing unit that performs a processing of applying the lens aberration to the obtained frame image. In a case where the obtained frame number is a frame number corresponding to the first clip, the processing unit obtains lens metadata, which indicates a correction quantity of the lens aberration of the obtained frame image, from the metadata of the first clip, and performs a processing of applying the lens aberration to the obtained frame image by using the lens metadata. In a case where the obtained frame number is not a frame number corresponding to the first clip and is a frame number preceding a head frame number of the first clip, the processing unit obtains lens metadata, which indicates a correction quantity of the lens aberration of a head frame image of the first clip, from the metadata of the first clip, and performs a processing of applying the lens aberration to the obtained frame image by using the lens metadata. In a case where the obtained frame number is not a frame number corresponding to the first clip and is a frame number after a final frame number of the first clip, the processing unit obtains lens metadata, which indicates a correction quantity of the lens aberration of a final frame image of the first clip, from the metadata of the first clip, and performs a processing of applying the lens aberration to the obtained frame image by using the lens metadata.

According to the present invention, it is possible to, in the combined clip obtained by combining the first clip, which has been obtained by removing the lens aberration from the moving image generated by photographing performed by the photographing apparatus, with the second clip composed of the images that do not have the lens aberration, reducing the sense of discontinuity at the switching point between the first clip and the second clip while imparting the atmosphere of actual-photographing to the second clip.

Further features of the present invention will become apparent from the following description of exemplary embodiments with reference to the attached drawings.

### BRIEF DESCRIPTION OF THE DRAWINGS

FIG. 1 is a block diagram that schematically shows a configuration of an information processing apparatus according to an embodiment of the present invention.

FIGS. 2A, 2B, 2C, and 2D are diagrams for explaining a moving image editing processing performed by the information processing apparatus shown in FIG. 1.

FIG. 3 is a diagram that shows an example of lens aberration metadata of a camera material clip shown in FIG. 2A and FIG. 2B.

FIG. 4 is a flowchart that shows the procedure of a lens aberration applying processing executed by the information processing apparatus in a first embodiment.

FIGS. 5A, 5B, and 5C are diagrams for explaining configurations of a combined clip and virtual camera information that are used in the lens aberration applying processing shown in FIG. 4.

FIG. 6 is a diagram for explaining a combined clip to which a lens aberration has been applied, which is outputted in the lens aberration applying processing shown in FIG. 4.

FIG. 7 is a flowchart that shows the procedure of a lens aberration applying processing executed by an information processing apparatus in a second embodiment.

FIG. 8A and FIG. 8B are diagrams for explaining a configuration of a combined clip that is used in the lens aberration applying processing shown in FIG. 7.

FIG. 9 is a diagram for explaining a combined clip to which a lens aberration has been applied, which is outputted in the lens aberration applying processing shown in FIG. 7.

FIG. 10 is a flowchart that shows the procedure of a lens aberration applying processing executed by an information processing apparatus in a third embodiment.

### DESCRIPTION OF THE EMBODIMENTS

The present invention will now be described in detail below with reference to the accompanying drawings showing embodiments thereof.

Hereafter, embodiments according to the present invention will be described in detail with reference to the accompanying drawings. It should be noted that in each of the embodiments according to the present invention, a personal computer (hereinafter, referred to as “a PC”) that handles moving image files (video files) will be described as an example of an information processing apparatus.

First, an information processing apparatus and a control method therefor according to a first embodiment of the present invention will be described.

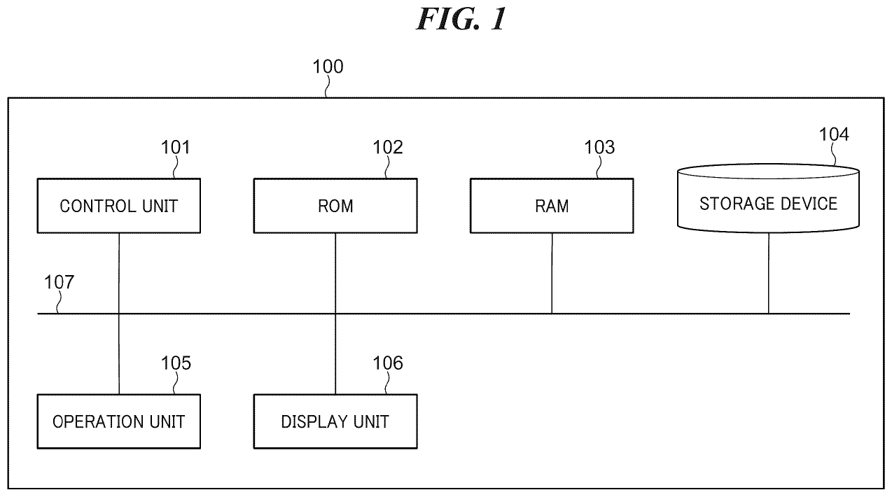

FIG. 1 is a block diagram that schematically shows a configuration of an information processing apparatus 100 according to the first embodiment of the present invention. As shown in FIG. 1, the information processing apparatus 100 includes a control unit 101, a read only memory (a ROM) 102, a random access memory (a RAM) 103, a storage device 104, an operation unit 105, and a display unit 106. The control unit 101, the ROM 102, the RAM 103, the storage device 104, the operation unit 105, and the display unit 106 are connected to each other via a bus 107.

The control unit 101 is, for example, a central processing unit (a CPU), and controls the entire information processing apparatus 100. The ROM 102 stores programs and parameters that do not require modification. For example, the ROM 102 stores a program of an application (hereinafter, referred to as “an image editing application”) for performing image editing. The RAM 103 temporarily stores programs and data that are obtained from external device(s) or the like. The storage device 104 is, for example, a hard disk or a flash memory. Alternatively, the storage device 104 may be an external storage device that is attachable to and detachable from the information processing apparatus 100, such as an optical disk such as a floppy disk (an FD) or a compact disk (a CD), a magnetic or optical card, an IC card, or a memory card. The operation unit 105 includes buttons and a touch panel that are used for inputting data, and accepts operations from a user. The display unit 106 displays data retained by the information processing apparatus 100, data obtained from an external device, etc.

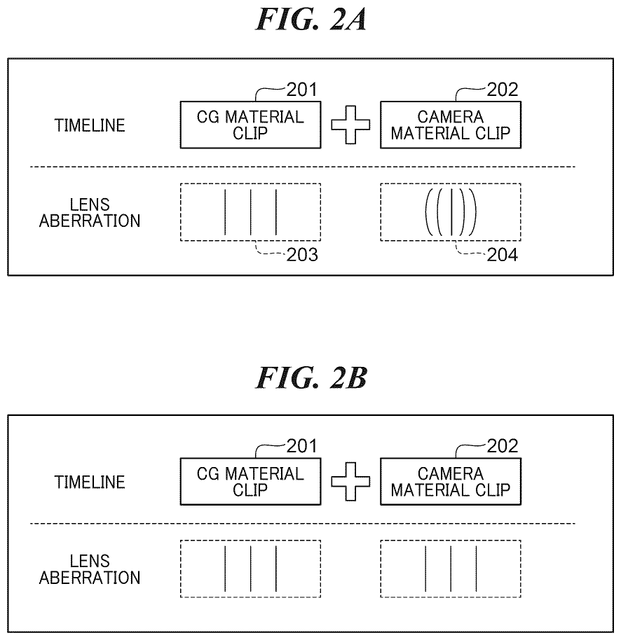

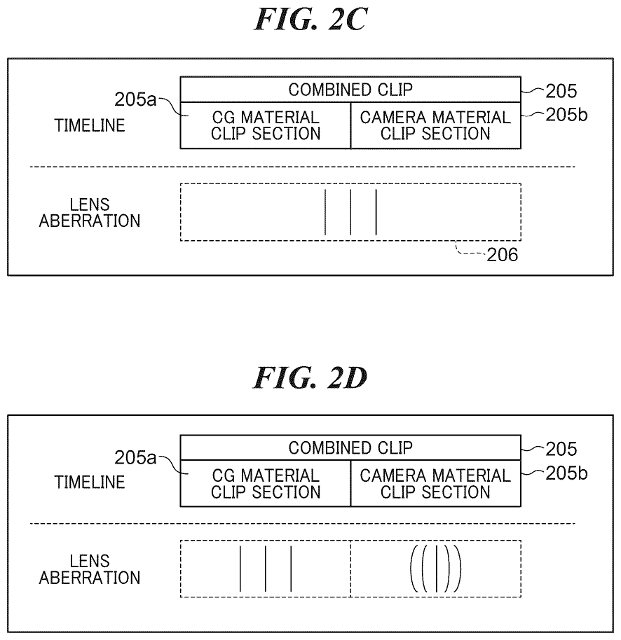

With the PC 100 (the information processing apparatus 100), the user causes the image editing application to load a moving image, which has been recorded by photographing with a digital camera (not shown) (a photographing apparatus), and performs an editing processing with respect to the moving image by using the image editing application. In the editing processing, for example, as shown in FIG. 2A, the user arranges a CG material clip 201 composed of computer graphic images (CG images) and a camera material clip 202 composed of the above-described moving image in this order on a timeline on the image editing application. It should be noted that the camera material clip 202 has been a lens aberration. For example, as shown in a conceptual image 204, the camera material clip 202 has been a distortion aberration. It should be noted that in the first embodiment, as an example of the lens aberration, a case where a distortion aberration has occurred will be described, but the lens aberration is not limited to a distortion aberration. The lens aberration may be, for example, a peripheral light falloff. On the other hand, the CG material clip 201 is not photographed by a photographing apparatus equipped with a lens, and therefore does not have a lens aberration (for example, see a conceptual image 203).

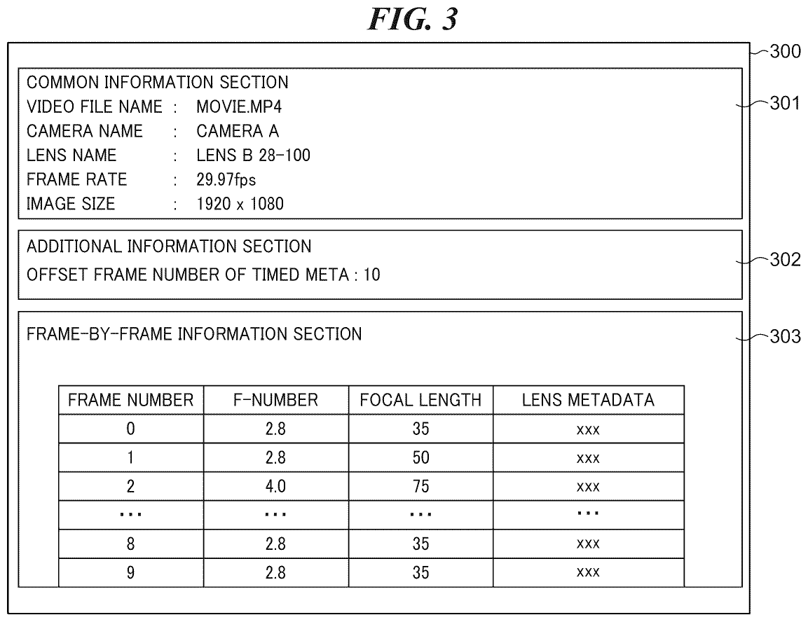

Next, the PC 100 performs a lens aberration removal processing. In the lens aberration removal processing, the PC 100 removes the lens aberration from the camera material clip 202 by using lens aberration metadata 300 shown in FIG. 3, which includes a photographing setting value, etc., which have been used in photographing of the moving image that constitutes the camera material clip 202. As a result, as shown in FIG. 2B, neither the camera material clip 202 nor the CG material clip 201 is in a state in which a lens aberration occurs.

FIG. 3 is a diagram that shows an example of the lens aberration metadata 300 of the camera material clip 202 shown in FIG. 2A and FIG. 2B. As shown in FIG. 3, the lens aberration metadata 300 includes a common information section 301, an additional information section 302, and a frame-by-frame information section 303. The lens aberration metadata 300 is in text format, with data for each frame recorded together with a frame number, separated by commas. The common information section 301 includes a moving image file name, a name of the camera that has performed photographing, a name of the lens that has been used when performing photographing, a frame rate that has been set when performing photographing, and an image size of the moving image. In the additional information section 302, the number of offset frames of timed meta (hereinafter, referred to as “an offset frame number of timed meta”), which will be described below, has been recorded. In the frame-by-frame information section 303, an F-number, a focal length, and lens metadata have been recorded in association with the frame number of each frame. The lens metadata is a correction quantity, which indicates how much correction to be applied to a distance from the center position of the image. In the first embodiment, a plurality of pieces of the lens metadata, which respectively indicate optimal correction quantities for a plurality of frame images that constitute the camera material clip 202, have been recorded in the frame-by-frame information section 303.

Upon completion of the lens aberration removal processing described above, the PC 100 creates a combined clip 205 shown in FIG. 2C by combining, in a time series manner, the CG material clip 201 with the camera material clip 202 from which the lens aberration has been removed. As shown in FIG. 2C, the combined clip 205 includes a CG material clip section 205a corresponding to the CG material clip 201, and a camera material clip section 205b corresponding to the camera material clip 202. The combined clip 205 is in a state in which no lens aberration occurs (for example, a state in which no distortion aberration occurs (see, a conceptual image 206 shown in FIG. 2C)).

Next, the PC 100 performs a lens aberration applying processing with respect to the combined clip 205. At this time, if the PC 100 uses only the lens aberration metadata 300 in the conventional manner, since the lens aberration metadata 300 includes only the lens metadata of the camera material clip 202, it is not possible to apply the lens aberration to the CG material clip section 205a. In other words, as shown in FIG. 2D, the combined clip 205 is in a state in which the lens aberration has been applied only to the camera material clip section 205b. As a result, it is not possible to impart an atmosphere of actual-photographing to the CG material clip section 205a, and a sense of discontinuity occurs at a switching point between the CG material clip section 205a and the camera material clip section 205b.

In order to deal with this issue, in the first embodiment, a frame image, to which the lens aberration has not been applied, is obtained from the combined clip 205, a frame number of the frame image is obtained, and a value of the focal length that has been preset in association with this frame number is obtained from virtual camera information 501. In addition, lens metadata corresponding to a value of the focal length closest to the value of the focal length that has been described above is obtained from the lens aberration metadata 300 of the camera material clip section 205b, and the lens aberration is applied to this frame image by using the lens metadata.

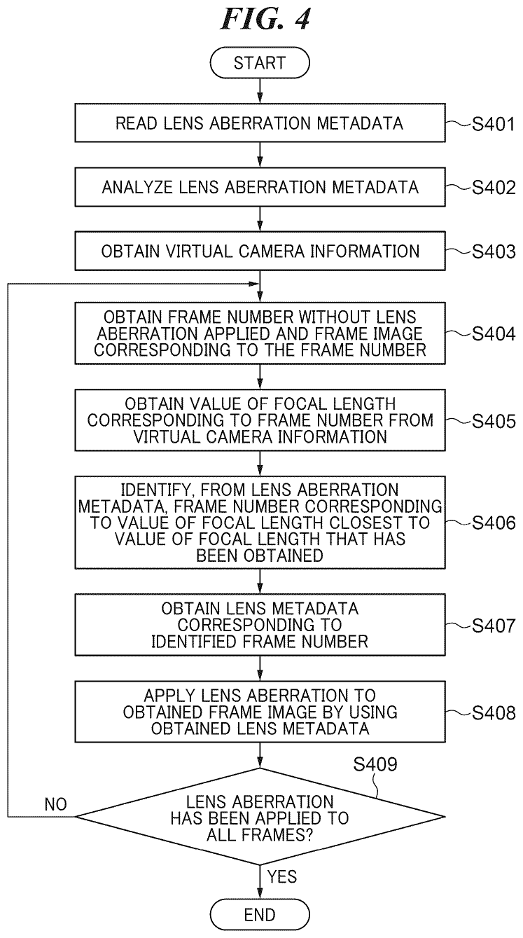

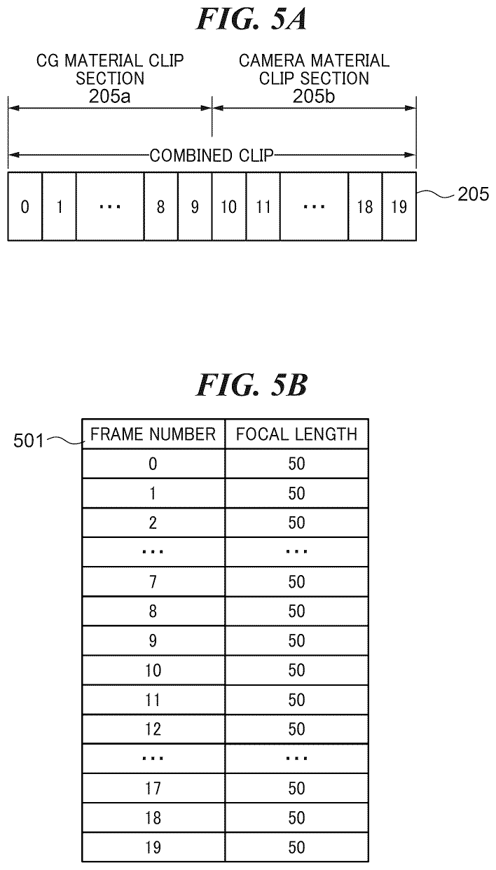

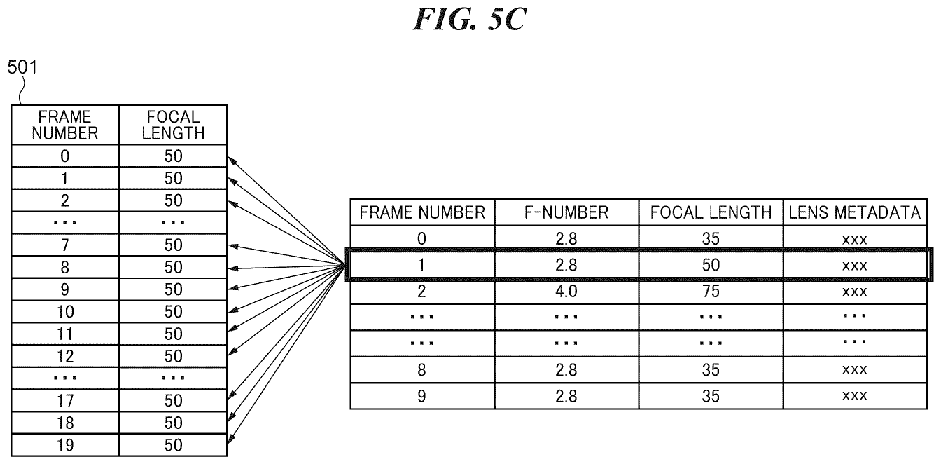

FIG. 4 is a flowchart that shows the procedure of a lens aberration applying processing executed by the information processing apparatus 100 in the first embodiment. The lens aberration applying processing shown in FIG. 4 is realized by the control unit 101 loading a program, which has been stored in the ROM 102 or the like, into the RAM 103 and executing it. It should be noted that in the first embodiment, as an example, it is assumed that the lens aberration applying processing is executed with respect to the combined clip 205. As described above, the combined clip 205 includes the CG material clip section 205a and the camera material clip section 205b, and the camera material clip section 205b is the camera material clip 202 from which the lens aberration has been removed. In addition, in the combined clip 205, as shown in FIG. 5A, it is assumed that the CG material clip section 205a is composed of ten frames from the 0-th frame to the 9-th frame of the combined clip 205. In addition, it is assumed that the camera material clip section 205b of the combined clip 205 is composed of ten frames from the 10-th frame to the 19-th frame of the combined clip 205. The lens aberration applying processing shown in FIG. 4 is executed when the user operates the operation unit 105 to designate the lens aberration metadata 300 corresponding to the combined clip 205. It should be noted that the lens aberration metadata 300 is the lens aberration metadata of the camera material clip 202 that constitutes the camera material clip section 205b in the combined clip 205.

As shown in FIG. 4, first, the control unit 101 loads (reads) the lens aberration metadata 300 that has been designated by the user (S401). Next, the control unit 101 analyzes the lens aberration metadata 300 that has been read (that has been loaded) (S402).

Next, the control unit 101 obtains the virtual camera information 501 of the combined clip 205, which is shown in FIG. 5B (S403). The virtual camera information 501 is a table that records the photographing setting value for each frame in the combined clip 205, and is used to determine which lens metadata to use for each frame of the combined clip 205 when applying the lens aberration. In the first embodiment, before the lens aberration applying processing shown in FIG. 4 is started, the user operates the operation unit 105 to set the photographing setting value for each frame in the combined clip 205 that is to be recorded in the virtual camera information 501. The virtual camera information 501 including the photographing setting value for each frame in the combined clip 205 that has been set by the user is stored in the storage device 104 or the like. In FIG. 5B, the focal length is recorded as an example of the photographing setting value, and the focal length has been set to “50” for all frames. It should be noted that in the first embodiment, a configuration will be described in which the focal length in the virtual camera information 501 is set to the same value for all frames, but a different value may be set for each frame. However, regarding the focal length in the virtual camera information 501, if there is a very large difference in values of the focal length between adjacent frames, there is a concern that there will be a large difference in the degree of the distortion or the degree of the peripheral light falloff between the adjacent frames, resulting in an unnatural moving image (an unnatural video). For this reason, regarding the focal length in the virtual camera information 501, in the case of setting a different value for each frame, it is necessary to set the focal length so that the difference in values of the focal length between adjacent frames is not too large.

Next, the control unit 101 obtains, from the combined clip 205, a frame number, to which the lens aberration has not been applied, and a frame image corresponding to this frame number (S404).

Next, the control unit 101 obtains, from the virtual camera information 501, a focal length corresponding to the frame number that has been obtained in S404 (S405). For example, in the case where the frame number that has been obtained in S404 is “0”, the control unit 101 obtains, from the virtual camera information 501, “50” that is the focal length corresponding to the frame number “0”.

Next, the control unit 101 identifies, from the lens aberration metadata 300, a frame number corresponding to a value of the focal length closest to the value of the focal length that has been obtained in S405 (S406). For example, in the case where the value of the focal length that has been obtained in S405 is “50”, in the frame-by-frame information section 303 of the lens aberration metadata 300 shown in FIG. 3, the value of the focal length closest to this value (“50”) is “50”, and a frame number corresponding to this value is “1”. Thus, in the case where the value of the focal length that has been obtained in S405 is “50”, in S406, the control unit 101 identifies the frame number corresponding to the value of the focal length closest to the value of the focal length that has been obtained in S405 as “1”.

Next, the control unit 101 obtains, from the frame-by-frame information section 303 of the lens aberration metadata 300, lens metadata corresponding to the frame number that has been identified in S406 (S407). For example, in the case where the frame number that has been identified in S406 is “1”, the control unit 101 obtains, from the frame-by-frame information section 303 of the lens aberration metadata 300, lens metadata corresponding to the frame number “1”.

Next, the control unit 101 applies the lens aberration to the frame image that has been obtained in S404 by using the lens metadata that has been obtained in S407 (S408). Next, the control unit 101 determines whether or not the lens aberration has been applied to all the frames of the combined clip 205 (S409).

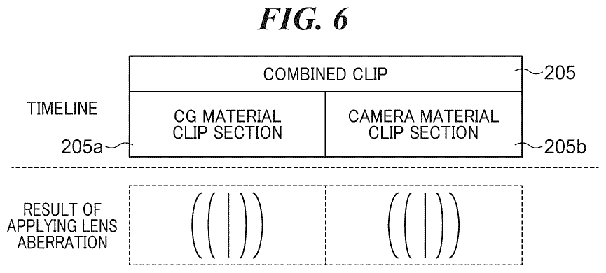

In the case of being determined in S409 that the lens aberration has not been applied to any frame of the combined clip 205, the lens aberration applying processing shown in FIG. 4 returns to S404, and a frame number, to which the lens aberration has not been applied, and a frame image corresponding to this frame number are obtained from the combined clip 205. In this way, the lens aberration is applied to all the frames of the combined clip 205. In the first embodiment, as an example, the value of the focal length has been set to “50” for all frames in the virtual camera information 501, and therefore the lens aberration is applied to each frame of the combined clip 205 by using the lens metadata for the frame number “1” that corresponds to the value of the focal length closest to this value (“50”) of the focal length (for example, see FIG. 5C). As a result, in the combined clip 205, as shown in FIG. 6, the lens aberration has been applied to both the CG material clip section 205a and the camera material clip section 205b.

In the case of being determined in S409 that the lens aberration has been applied to all the frames of the combined clip 205, the lens aberration applying processing shown in FIG. 4 ends.

According to the first embodiment that has been described above, a frame image, to which the lens aberration has not been applied, is obtained from the combined clip 205, a frame number of the frame image is obtained, and a value of the focal length that has been preset in association with this frame number is obtained from virtual camera information 501. In addition, lens metadata corresponding to a value of the focal length closest to the value of the focal length that has been described above is obtained from the lens aberration metadata 300 of the camera material clip section 205b, and the lens aberration is applied to this frame image by using the lens metadata. In other words, the lens aberration is applied not only to the camera material clip section 205b but also to the CG material clip section 205a. As a result, in the combined clip 205, it is possible to impart the atmosphere of actual-photographing to the CG material clip section 205a. In addition, when applying the lens aberration, since the lens metadata included in the lens aberration metadata 300 of the camera material clip section 205b is used, the lens aberration is applied to the CG material clip section 205a in the same manner (in the same degree) as to the camera material clip section 205b. As a result, it is possible to reduce the sense of discontinuity at the switching point between the CG material clip section 205a and the camera material clip section 205b. Therefore, in the first embodiment described above, in the combined clip 205, it is possible to reduce the sense of discontinuity at the switching point between the CG material clip section 205a and the camera material clip section 205b while imparting the atmosphere of actual-photographing to the CG material clip section 205a.

In addition, in the first embodiment described above, the virtual camera information 501 is set by the user. As a result, the degree of the distortion or the degree of the peripheral light falloff that is to be added to the combined clip 205 is capable of being adjusted to reflect the user's intention.

It should be noted that in the first embodiment described above, the configuration has been described in which the value of the focal length is set as the photographing setting value in the virtual camera information 501, but the configuration of the virtual camera information 501 is not limited to this. For example, the virtual camera information 501 may be configured to include value(s) other than the focal length as the photographing setting value. The value(s) other than the focal length include, for example, subject distance information that affects the moving image (the video) photographed by the camera, such as an F-number or a T-number, and a photographing setting value that affects an optical system.

In addition, in the present embodiment, the virtual camera information 501 may be configured to include a plurality of types of values, for example, include both the value of the focal length and the F-number, as the photographing setting value.

In addition, in the present embodiment, a configuration may be adopted in which the user is allowed to select items (the focal length and the F-number) to be included in the virtual camera information 501 as the photographing setting value.

In addition, in the present embodiment, the file structure of the lens aberration metadata 300 is not limited to the structure shown in FIG. 3 described above, and may be a structure in JavaScript Object Notation (JSON) format or the like.

In addition, the lens aberration metadata 300 may be recorded in a moving image file (a video file) by the digital camera when photographing a moving image (a video), or may be created by the information processing apparatus 100 from a moving image file (a video file) in which metadata for each frame has been recorded.

In the embodiment described above, the information processing apparatus 100 is configured to load (read) the file in which the lens aberration metadata 300 has been recorded, but the present invention is not limited to this configuration. For example, a configuration may be adopted in which the lens aberration metadata 300 is embedded in the moving image file itself as timed metadata that changes for each frame, and the information processing apparatus 100 obtains the lens aberration metadata 300 from the moving image file.

In addition, in the present embodiment, a configuration may be adopted in which the user is allowed to select the lens aberration to be applied, and the items (the focal length and the F-number) to be included in the virtual camera information 501 as the photographing setting value may be decided in accordance with the lens aberration to be applied.

Next, an information processing apparatus and a control method therefor according to a second embodiment of the present invention will be described.

The second embodiment is basically the same as the first embodiment described above in terms of configuration and operation, but differs from the first embodiment described above in that a lens aberration is applied to all frame images that constitute a combined clip without using virtual camera information. Therefore, descriptions of overlapping configurations and operations will be omitted, and only different configurations and operations will be described below.

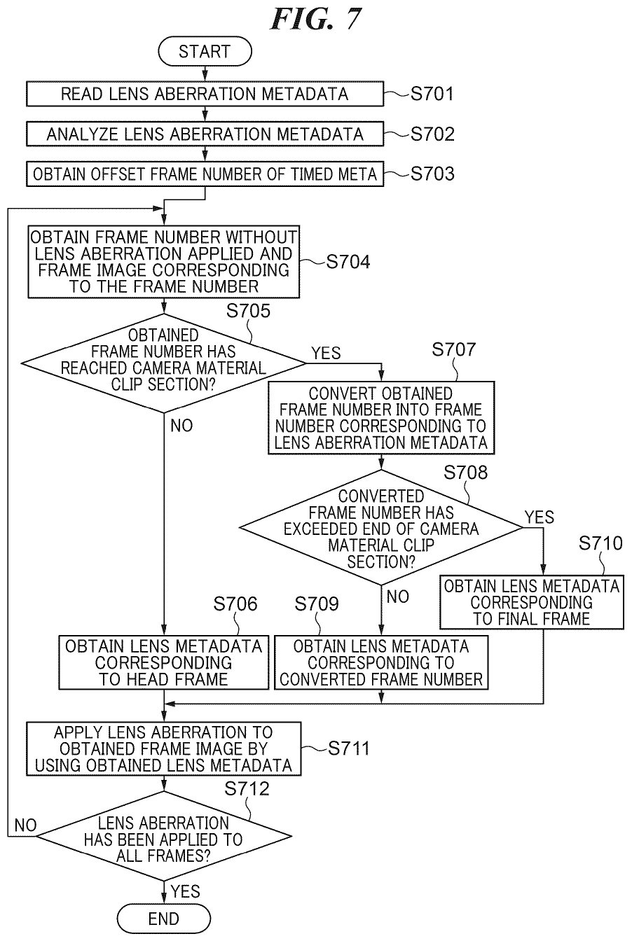

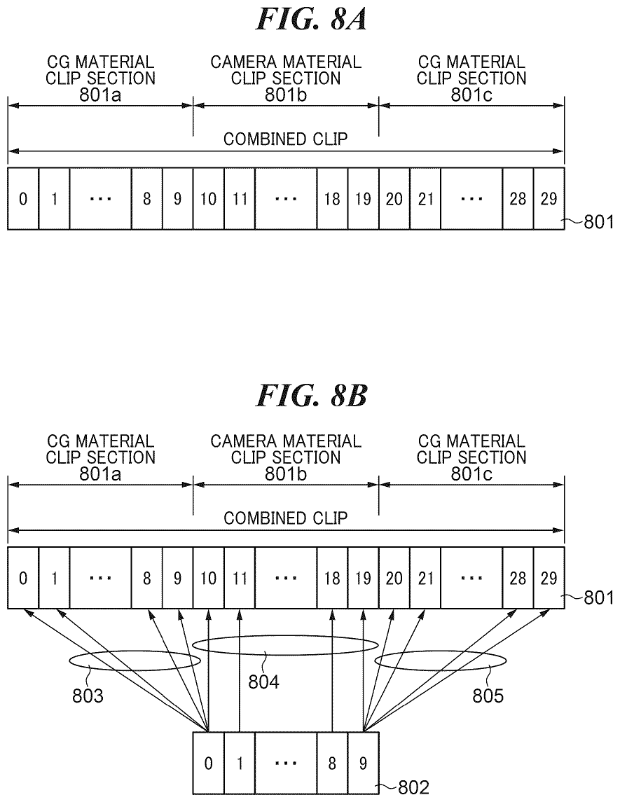

FIG. 7 is a flowchart that shows the procedure of a lens aberration applying processing executed by an information processing apparatus 100 in the second embodiment. It should be noted that the lens aberration applying processing shown in FIG. 7 is similar to the lens aberration applying processing shown in FIG. 4, which has been described above, and the following will particularly describe the differences from the lens aberration applying processing shown in FIG. 4, which has been described above. Similar to the lens aberration applying processing shown in FIG. 4, which has been described above, the lens aberration applying processing shown in FIG. 7 is also realized by the control unit 101 loading a program, which has been stored in the ROM 102 or the like, into the RAM 103 and executing it. It should be noted that in the second embodiment, as an example, it is assumed that the lens aberration applying processing is executed with respect to a combined clip 801 shown in FIG. 8A and FIG. 8B. The combined clip 801 includes a CG material clip section 801a, a camera material clip section 801b, and a CG material clip section 801c, and the camera material clip section 801b is the camera material clip 202 from which the lens aberration has been removed. The CG material clip section 801a is composed of ten frames from the 0-th frame to the 9-th frame of the combined clip 801. The camera material clip section 801b is composed of ten frames from the 10-th frame to the 19-th frame of the combined clip 801. The CG material clip section 801c is composed of ten frames from the 20-th frame to the 29-th frame of the combined clip 801. The lens aberration applying processing shown in FIG. 7 is executed when the user operates the operation unit 105 to designate the lens aberration metadata 300 corresponding to the combined clip 801. It should be noted that the lens aberration metadata 300 is the lens aberration metadata of the camera material clip 202 that constitutes the camera material clip section 801b in the combined clip 801.

As shown in FIG. 7, first, S701 and S702, which are the same processes as S401 and S402 that have been described above, are performed. Next, the control unit 101 obtains, from the additional information section 302 of the lens aberration metadata 300, an offset frame number of timed meta (the number of offset frames of the timed meta) (S703). The offset frame number is a value indicating the position of a start frame of the camera material clip section 801b in the combined clip 801. In the second embodiment, since the CG material clip section 801a, which is composed of ten frames, has been arranged before a head frame (the start frame) of the camera material clip section 801b, as the offset frame number of the timed meta, “10” has been set in the additional information section 302.

Next, the control unit 101 obtains, from the combined clip 801, a frame number, to which the lens aberration has not been applied, and a frame image corresponding to this frame number (S704). Next, the control unit 101 determines whether or not the frame number that has been obtained in S704 has reached the camera material clip section 801b (S705). Specifically, the control unit 101 determines whether or not the frame number that has been obtained in S704 has reached “10”, which is the offset frame number that has been obtained in S703.

In S705, in the case where the frame number that has been obtained in S704 does not reach “10”, which is the offset frame number that has been obtained in S703, it is determined that the frame number that has been obtained in S704 does not reach the camera material clip section 801b. In this case, the lens aberration applying processing shown in FIG. 7 proceeds to S706.

In S706, the control unit 101 obtains, from the frame-by-frame information section 303 of the lens aberration metadata 300, lens metadata corresponding to the head frame. In this way, in the second embodiment, in the case where the frame number that has been obtained in S704 is not a frame number corresponding to the camera material clip section 801b and is a frame number preceding a head frame number of the camera material clip section 801b, the lens metadata corresponding to the head frame of the camera material clip section 801b is obtained from the lens aberration metadata 300. Next, the lens aberration applying processing shown in FIG. 7 proceeds to S711, which will be described below.

In S705, in the case where the frame number that has been obtained in S704 has reached “10”, which is the offset frame number that has been obtained in S703, it is determined that the frame number that has been obtained in S704 has reached the camera material clip section 801b. In this case, the lens aberration applying processing shown in FIG. 7 proceeds to S707.

In S707, the control unit 101 converts the frame number that has been obtained in S704 into a frame number corresponding to the lens aberration metadata 300. Specifically, the control unit 101 subtracts the offset frame number of the timed meta (the number of the offset frames of the timed meta) that has been obtained in S703 from the frame number that has been obtained in S704. For example, “0” is obtained by subtracting “10”, which is the offset frame number of the timed meta (the number of the offset frames of the timed meta) that has been obtained in S703, from “10”, which is the frame number that has been obtained in S704. “0” corresponds to the head frame number of the camera material clip section 801b in the lens aberration metadata 300. In this way, in S707, the frame number that has been obtained in S704 is converted into the frame number corresponding to the lens aberration metadata 300.

Next, the control unit 101 determines whether or not the converted frame number has exceeded the end of the camera material clip section 801b (S708). Specifically, the control unit 101 determines whether or not the converted frame number has exceeded “9”, which is a frame number of a final frame of the camera material clip section 801b.

In S708, in the case where the converted frame number does not exceed “9”, which is the frame number of the final frame of the camera material clip section 801b, it is determined that the converted frame number does not exceed the end of the camera material clip section 801b. In this case, the lens aberration applying processing shown in FIG. 7 proceeds to S709.

In S709, the control unit 101 obtains, from the frame-by-frame information section 303 of the lens aberration metadata 300, lens metadata corresponding to the converted frame number. In this way, in the second embodiment, in the case where the frame number that has been obtained in S704 is the frame number corresponding to the camera material clip section 801b, lens metadata, which indicates the correction quantity of the lens aberration of the frame image that has been obtained in S704, is obtained from the lens aberration metadata 300. Next, the lens aberration applying processing shown in FIG. 7 proceeds to S711, which will be described below.

In S708, in the case where the converted frame number has exceeded “9”, which is the frame number of the final frame of the camera material clip section 801b, it is determined that the converted frame number has exceeded the end of the camera material clip section 801b. In this case, the lens aberration applying processing shown in FIG. 7 proceeds to S710.

In S710, the control unit 101 obtains, from the frame-by-frame information section 303 of the lens aberration metadata 300, lens metadata corresponding to the final frame. In this way, in the second embodiment, in the case where the frame number that has been obtained in S704 is not the frame number corresponding to the camera material clip section 801b and is a frame number after a final frame number of the camera material clip section 801b, the lens metadata corresponding to the final frame of the camera material clip section 801b is obtained from the lens aberration metadata 300.

Next, the control unit 101 applies the lens aberration to the frame image that has been obtained in S704 by using the lens metadata that has been obtained in S706, S709, or S710 (S711).

For example, the lens aberration is applied to the CG material clip section 801a that has been arranged before the head frame of the camera material clip section 801b by using the lens metadata that has been obtained in S706, that is, by using the lens metadata of the head frame of the camera material clip section 801b (for example, see a reference numeral 803 shown in FIG. 8B). It should be noted that a reference numeral 802 shown in FIG. 8B denotes lens metadata corresponding to each frame number included in the frame-by-frame information section 303 of the lens aberration metadata 300.

In addition, the lens aberration is applied to the camera material clip section 801b by using the lens metadata that has been obtained in S709, that is, by using the lens metadata corresponding to each frame number of the camera material clip section 801b (for example, see a reference numeral 804 shown in FIG. 8B).

In addition, the lens aberration is applied to the CG material clip section 801c that has been arranged after the final frame of the camera material clip section 801b by using the lens metadata that has been obtained in S710, that is, by using the lens metadata of the final frame of the camera material clip section 801b (for example, see a reference numeral 805 shown in FIG. 8B).

Next, the control unit 101 determines whether or not the lens aberration has been applied to all the frames of the combined clip 801 (S712).

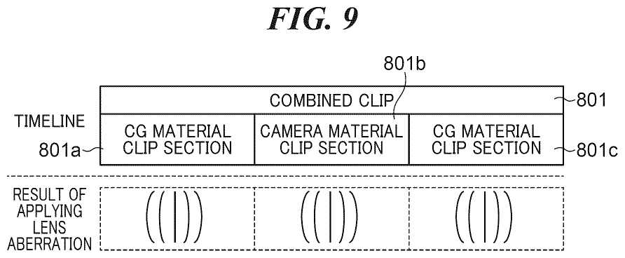

In the case of being determined in S712 that the lens aberration has not been applied to any frame of the combined clip 801, the lens aberration applying processing shown in FIG. 7 returns to S704, and a frame number, to which the lens aberration has not been applied, and a frame image corresponding to this frame number are obtained from the combined clip 801. In this way, the lens aberration is applied to all the frames of the combined clip 801. As a result, in the combined clip 801, as shown in FIG. 9, the lens aberration has been applied to all of the CG material clip section 801a, the camera material clip section 801b, and the CG material clip section 801c.

In the case of being determined in S712 that the lens aberration has been applied to all the frames of the combined clip 801, the lens aberration applying processing shown in FIG. 7 ends.

In the second embodiment that has been described above, a frame image, to which the lens aberration has not been applied, is obtained from the combined clip 801, and a frame number of the frame image is obtained. In the case where this frame number is the frame number corresponding to the camera material clip section 801b, lens metadata, which indicates the correction quantity of the lens aberration of this frame image, is obtained from the lens aberration metadata 300 of the camera material clip section 801b, and the lens aberration is applied to this frame image by using the lens metadata. In addition, in the case where this frame number is not the frame number corresponding to the camera material clip section 801b and is a frame number preceding the head frame number of the camera material clip section 801b, lens metadata, which indicates the correction quantity of the lens aberration of a head frame image of the camera material clip section 801b, is obtained from the lens aberration metadata 300 of the camera material clip section 801b, and the lens aberration is applied to this frame image by using the lens metadata. In addition, in the case where this frame number is not the frame number corresponding to the camera material clip section 801b and is a frame number after the final frame number of the camera material clip section 801b, lens metadata, which indicates the correction quantity of the lens aberration of a final frame image of the camera material clip section 801b, is obtained from the lens aberration metadata 300 of the camera material clip section 801b, and the lens aberration is applied to this frame image by using the lens metadata. In other words, the lens aberration is applied not only to the camera material clip section 801b but also to the CG material clip section 801a and the CG material clip section 801c. As a result, in the combined clip 801, it is possible to impart the atmosphere of actual-photographing to the CG material clip section 801a and the CG material clip section 801c. In addition, the lens aberration is applied to each of the CG material clip section 801a and the CG material clip section 801c by using the lens metadata that indicates the correction quantity of the lens aberration of the frame image of the adjacent camera material clip section 801b. As a result, it is possible to reduce the sense of discontinuity at a switching point between the CG material clip section 801a and the camera material clip section 801b and the sense of discontinuity at a switching point between the CG material clip section 801c and the camera material clip section 801b. Therefore, in the second embodiment described above, in the combined clip 801, it is possible to reduce the sense of discontinuity at the switching point between the CG material clip section and the camera material clip section while imparting the atmosphere of actual-photographing to the CG material clip section.

In addition, in the second embodiment described above, the offset frame number of the timed meta (the number of the offset frames of the timed meta) for identifying the start frame of the camera material clip section 801b in the combined clip 801 is used to determine whether or not the obtained frame number is the frame number corresponding to the camera material clip section 801b. As a result, it is possible to reliably determine whether or not the obtained frame number is the frame number corresponding to the camera material clip section 801b.

It should be noted that in the second embodiment described above, the configuration has been described in which the lens aberration metadata 300 includes the offset frame number of the timed meta (the number of the offset frames of the timed meta), but the present invention is not limited to this configuration. For example, a configuration may be adopted in which the user is allowed to set the offset frame number of the timed meta (the number of the offset frames of the timed meta) on a setting screen of the image editing application.

Next, an information processing apparatus and a control method therefor according to a third embodiment of the present invention will be described.

The third embodiment is basically the same as the first embodiment and the second embodiment that have been described above in terms of configuration and operation, but differs from the first embodiment and the second embodiment that have been described above in that the control for applying the lens aberration is switched based on whether or not the virtual camera information 501 has been obtained. Therefore, descriptions of overlapping configurations and operations will be omitted, and only different configurations and operations will be described below.

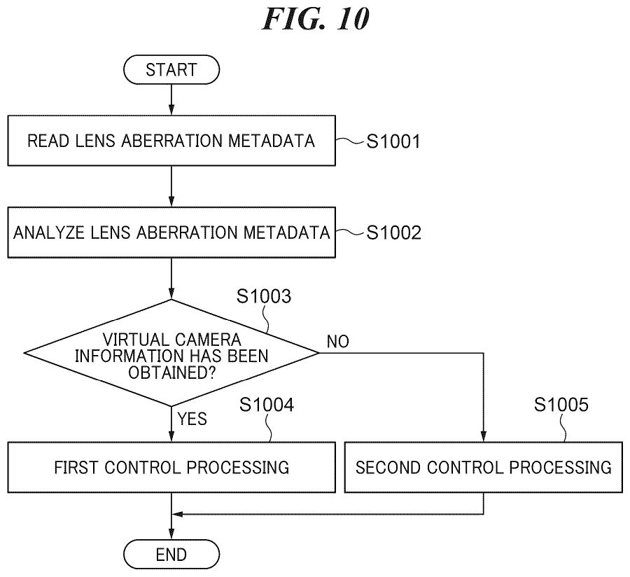

FIG. 10 is a flowchart that shows the procedure of a lens aberration applying processing executed by an information processing apparatus 100 in the third embodiment. It should be noted that the lens aberration applying processing shown in FIG. 10 is similar to the lens aberration applying processing shown in FIG. 4 and the lens aberration applying processing shown in FIG. 7, which have been described above, and the following will particularly describe the differences from the lens aberration applying processing shown in FIG. 4 and the lens aberration applying processing shown in FIG. 7, which have been described above. Similar to the lens aberration applying processing shown in FIG. 4 and the lens aberration applying processing shown in FIG. 7, which have been described above, the lens aberration applying processing shown in FIG. 10 is also realized by the control unit 101 loading a program, which has been stored in the ROM 102 or the like, into the RAM 103 and executing it. It should be noted that in the third embodiment, as an example, it is assumed that the lens aberration applying processing is executed with respect to the combined clip 205. The lens aberration applying processing shown in FIG. 10 is executed when the user operates the operation unit 105 to designate the lens aberration metadata 300 corresponding to the combined clip 205. It should be noted that the lens aberration metadata 300 is the lens aberration metadata of the camera material clip 202 that constitutes the camera material clip section 205b in the combined clip 205.

As shown in FIG. 10, first, S1001 and S1002, which are the same processes as S401 and S402 that have been described above, are performed. Next, the control unit 101 attempts to obtain the virtual camera information 501, and determines whether or not the virtual camera information 501 has been obtained (S1003).

In the case of being determined in S1003 that the virtual camera information 501 has been obtained, the control unit 101 performs a first control processing. In the first control processing, the processes of S404 to S409, which have been described above, are performed. Thereafter, the lens aberration applying processing shown in FIG. 10 ends.

In the case of being determined in S1003 that the virtual camera information 501 has not been obtained, the control unit 101 performs a second control processing. In the second control processing, the processes of S703 to S712, which have been described above, are performed. Thereafter, the lens aberration applying processing shown in FIG. 10 ends.

In this way, with the configuration in which the control for applying the lens aberration is switched based on whether or not the virtual camera information 501 has been obtained, it is also possible to achieve the same effects as in the above-described embodiments.

It should be noted that in the present embodiment, the case where the present invention is applied to a PC, which is an example of the information processing apparatus 100, has been described, but the present invention is also capable of being applied to a smartphone or a tablet terminal.

In addition, in the present embodiment, the case, in which the CG material clip composed of the CG images is used as the material clip composed of the images that do not have the lens aberration, has been described as an example, but the present invention is not limited to this case. For example, the present invention is also applicable to a case where a material clip, which is composed of images other than CG images and do not have the lens aberration, such as images obtained by scanning with a scanning device, is used. In addition, the present invention is also capable of being applied to a digital camera, into which such material clip(s) have been imported.

The present invention has been described above in detail based on its preferred embodiments, but the present invention is not limited to these specific embodiments, and various forms that do not deviate from the gist of the present invention are also included in the present invention. Some of the above-described embodiments may be combined as appropriate. The present invention also includes a case where a software program that realizes the functions of the above-described embodiments is supplied to a system or an apparatus having a computer capable of executing the program directly from a recording medium or via wired/wireless communication, and the program is executed. Therefore, the program codes itself that are supplied to and installed in a computer to realize the functional processing of the present invention also realize the present invention. In other words, the computer program itself for realizing the functional processing of the present invention is also included in the present invention. In this case, so long as the program has the functions of a program, the program may be in any form, such as object codes, a program executed by an interpreter, or script data supplied to an operating system (an OS). The recording medium for supplying the program may be, for example, a hard disk, a magnetic recording medium such as a magnetic tape, an optical/magneto-optical storage medium, or a non-volatile semiconductor memory. In addition, as a method of supplying the program, a method is also conceivable in which the computer program constituting the present invention is stored in a server on a computer network, and a connected client computer downloads the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus that generates a combined clip by combining a first clip, which has been obtained by removing a lens aberration from a moving image generated by photographing performed by a photographing apparatus, with a second clip, which is composed of images that do not have the lens aberration, the information processing apparatus comprising:
at least one processor; and
a memory coupled to the processor storing instructions that, when executed by the processor, cause the processor to function as:
a reading unit that reads metadata of the first clip in which a plurality of pieces of lens metadata corresponding to a plurality of frame images constituting the first clip, respectively, are recorded in association with a photographing setting value used in the photographing, the plurality of pieces of lens metadata each indicating a correction quantity of the lens aberration;
an obtaining unit that obtains a frame image, to which the lens aberration has not been applied, from among a plurality of frame images constituting the combined clip, and obtains a frame number of the frame image in the combined clip;
a photographing setting value obtaining unit that obtains a first photographing setting value that has been preset in association with the obtained frame number; and
a processing unit that obtains lens metadata corresponding to a second photographing setting value, which is closest to the obtained first photographing setting value, from the metadata of the first clip, and performs a processing of applying the lens aberration to the obtained frame image by using the lens metadata.

2. The information processing apparatus according to claim 1, wherein the first photographing setting value is set by a user.

3. The information processing apparatus according to claim 1, wherein the first photographing setting value is at least one of a value of a focal length and an F-number.

4. The information processing apparatus according to claim 1, wherein the processor is caused to further function as a determining unit that determines whether or not the first photographing setting value has been obtained,
in a case of being determined that the first photographing setting value has not been obtained, the processing unit performs a processing of applying the lens aberration without using the first photographing setting value, and
in the processing of applying the lens aberration without using the first photographing setting value,
in a case where the obtained frame number is a frame number corresponding to the first clip, the processing unit obtains lens metadata, which indicates a correction quantity of the lens aberration of the obtained frame image, from the metadata of the first clip, and performs a processing of applying the lens aberration to the obtained frame image by using the lens metadata,
in a case where the obtained frame number is not a frame number corresponding to the first clip and is a frame number preceding a head frame number of the first clip, the processing unit obtains lens metadata, which indicates a correction quantity of the lens aberration of a head frame image of the first clip, from the metadata of the first clip, and performs a processing of applying the lens aberration to the obtained frame image by using the lens metadata, and
in a case where the obtained frame number is not a frame number corresponding to the first clip and is a frame number after a final frame number of the first clip, the processing unit obtains lens metadata, which indicates a correction quantity of the lens aberration of a final frame image of the first clip, from the metadata of the first clip, and performs a processing of applying the lens aberration to the obtained frame image by using the lens metadata.

5. An information processing apparatus that generates a combined clip by combining a first clip, which has been obtained by removing a lens aberration from a moving image generated by photographing performed by a photographing apparatus, with a second clip, which is composed of images that do not have the lens aberration, the information processing apparatus comprising:
at least one processor; and
a memory coupled to the processor storing instructions that, when executed by the processor, cause the processor to function as:
a reading unit that reads metadata of the first clip in which a plurality of pieces of lens metadata corresponding to a plurality of frame images constituting the first clip, respectively, are recorded, the plurality of pieces of lens metadata each indicating a correction quantity of the lens aberration;
an obtaining unit that obtains a frame image, to which the lens aberration has not been applied, from among a plurality of frame images constituting the combined clip, and obtains a frame number of the frame image in the combined clip; and
a processing unit that performs a processing of applying the lens aberration to the obtained frame image, and
wherein, in a case where the obtained frame number is a frame number corresponding to the first clip, the processing unit obtains lens metadata, which indicates a correction quantity of the lens aberration of the obtained frame image, from the metadata of the first clip, and performs a processing of applying the lens aberration to the obtained frame image by using the lens metadata,
in a case where the obtained frame number is not a frame number corresponding to the first clip and is a frame number preceding a head frame number of the first clip, the processing unit obtains lens metadata, which indicates a correction quantity of the lens aberration of a head frame image of the first clip, from the metadata of the first clip, and performs a processing of applying the lens aberration to the obtained frame image by using the lens metadata, and
in a case where the obtained frame number is not a frame number corresponding to the first clip and is a frame number after a final frame number of the first clip, the processing unit obtains lens metadata, which indicates a correction quantity of the lens aberration of a final frame image of the first clip, from the metadata of the first clip, and performs a processing of applying the lens aberration to the obtained frame image by using the lens metadata.

6. The information processing apparatus according to claim 5, wherein the processor is caused to further function as a determining unit that determines whether or not the obtained frame number is a frame number corresponding to the first clip, and
the determining unit determines whether or not the obtained frame number is a frame number corresponding to the first clip by using information for identifying a start frame of the first clip in the combined clip.

7. The information processing apparatus according to claim 1, wherein the lens aberration is at least one of a peripheral light falloff and a distortion aberration.

8. The information processing apparatus according to claim 5, wherein the lens aberration is at least one of a peripheral light falloff and a distortion aberration.

9. The information processing apparatus according to claim 1, wherein the images that do not have the lens aberration are computer graphic images (CG images).

10. The information processing apparatus according to claim 5, wherein the images that do not have the lens aberration are computer graphic images (CG images).

11. A control method for controlling an information processing apparatus that generates a combined clip by combining a first clip, which has been obtained by removing a lens aberration from a moving image generated by photographing performed by a photographing apparatus, with a second clip, which is composed of images that do not have the lens aberration, the control method comprising:
a step of reading metadata of the first clip in which a plurality of pieces of lens metadata corresponding to a plurality of frame images constituting the first clip, respectively, are recorded in association with a photographing setting value used in the photographing, the plurality of pieces of lens metadata each indicating a correction quantity of the lens aberration;
a step of obtaining a frame image, to which the lens aberration has not been applied, from among a plurality of frame images constituting the combined clip, and obtaining a frame number of the frame image in the combined clip;
a step of obtaining a first photographing setting value that has been preset in association with the obtained frame number; and
a step of obtaining lens metadata corresponding to a second photographing setting value, which is closest to the obtained first photographing setting value, from the metadata of the first clip, and performing a processing of applying the lens aberration to the obtained frame image by using the lens metadata.

12. A control method for controlling an information processing apparatus that generates a combined clip by combining a first clip, which has been obtained by removing a lens aberration from a moving image generated by photographing performed by a photographing apparatus, with a second clip, which is composed of images that do not have the lens aberration, the control method comprising:
a step of reading metadata of the first clip in which a plurality of pieces of lens metadata corresponding to a plurality of frame images constituting the first clip, respectively, are recorded, the plurality of pieces of lens metadata each indicating a correction quantity of the lens aberration;
a step of obtaining a frame image, to which the lens aberration has not been applied, from among a plurality of frame images constituting the combined clip, and obtaining a frame number of the frame image in the combined clip; and
a processing step of performing a processing of applying the lens aberration to the obtained frame image, and
wherein, in a case where the obtained frame number is a frame number corresponding to the first clip, in the processing step, lens metadata, which indicates a correction quantity of the lens aberration of the obtained frame image, is obtained from the metadata of the first clip, and a processing of applying the lens aberration to the obtained frame image is performed by using the lens metadata,
in a case where the obtained frame number is not a frame number corresponding to the first clip and is a frame number preceding a head frame number of the first clip, in the processing step, lens metadata, which indicates a correction quantity of the lens aberration of a head frame image of the first clip, is obtained from the metadata of the first clip, and a processing of applying the lens aberration to the obtained frame image is performed by using the lens metadata, and
in a case where the obtained frame number is not a frame number corresponding to the first clip and is a frame number after a final frame number of the first clip, in the processing step, lens metadata, which indicates a correction quantity of the lens aberration of a final frame image of the first clip, is obtained from the metadata of the first clip, and a processing of applying the lens aberration to the obtained frame image is performed by using the lens metadata.

13. A non-transitory computer-readable storage medium storing a program for causing a computer to execute a control method for an information processing apparatus that generates a combined clip by combining a first clip, which has been obtained by removing a lens aberration from a moving image generated by photographing performed by a photographing apparatus, with a second clip, which is composed of images that do not have the lens aberration, the control method comprising:
a step of reading metadata of the first clip in which a plurality of pieces of lens metadata corresponding to a plurality of frame images constituting the first clip, respectively, are recorded in association with a photographing setting value used in the photographing, the plurality of pieces of lens metadata each indicating a correction quantity of the lens aberration;
a step of obtaining a frame image, to which the lens aberration has not been applied, from among a plurality of frame images constituting the combined clip, and obtaining a frame number of the frame image in the combined clip;
a step of obtaining a first photographing setting value that has been preset in association with the obtained frame number; and
a step of obtaining lens metadata corresponding to a second photographing setting value, which is closest to the obtained first photographing setting value, from the metadata of the first clip, and performing a processing of applying the lens aberration to the obtained frame image by using the lens metadata.

14. A non-transitory computer-readable storage medium storing a program for causing a computer to execute a control method for an information processing apparatus that generates a combined clip by combining a first clip, which has been obtained by removing a lens aberration from a moving image generated by photographing performed by a photographing apparatus, with a second clip, which is composed of images that do not have the lens aberration, the control method comprising:
a step of reading metadata of the first clip in which a plurality of pieces of lens metadata corresponding to a plurality of frame images constituting the first clip, respectively, are recorded, the plurality of pieces of lens metadata each indicating a correction quantity of the lens aberration;
a step of obtaining a frame image, to which the lens aberration has not been applied, from among a plurality of frame images constituting the combined clip, and obtaining a frame number of the frame image in the combined clip; and
a processing step of performing a processing of applying the lens aberration to the obtained frame image, and
wherein, in a case where the obtained frame number is a frame number corresponding to the first clip, in the processing step, lens metadata, which indicates a correction quantity of the lens aberration of the obtained frame image, is obtained from the metadata of the first clip, and a processing of applying the lens aberration to the obtained frame image is performed by using the lens metadata,
in a case where the obtained frame number is not a frame number corresponding to the first clip and is a frame number preceding a head frame number of the first clip, in the processing step, lens metadata, which indicates a correction quantity of the lens aberration of a head frame image of the first clip, is obtained from the metadata of the first clip, and a processing of applying the lens aberration to the obtained frame image is performed by using the lens metadata, and
in a case where the obtained frame number is not a frame number corresponding to the first clip and is a frame number after a final frame number of the first clip, in the processing step, lens metadata, which indicates a correction quantity of the lens aberration of a final frame image of the first clip, is obtained from the metadata of the first clip, and a processing of applying the lens aberration to the obtained frame image is performed by using the lens metadata.
